(19) United States
(12) Patent Application Publication
(10) Pub. No.: US 2017/0371782 A1
(43) Pub. Date: Dec. 28, 2017

(54) VIRTUAL STORAGE

(71) Applicant: HEWLETT PACKARD ENTERPRISE DEVELOPMENT LP, Houston, TX (US)

(72) Inventors: Nathaniel S DeNeui, Houston, TX (US); Joseph David Black, Houston, TX (US)

(21) Appl. No.: 15/540,353

(22) PCT Filed: Jan. 21, 2015
(86) PCT No.: PCT/US2015/012184

§ 371 Date: Jun. 28, 2017

(51) Int. Cl. G06F 12/08; G06F 12/06; G06F 3/06

(52) U.S. Cl. CPC G06F 12/08; G06F 3/0689; G06F 12/06

(57) ABSTRACT

In some examples, techniques for virtual storage includes configuring a single physical storage disk to a virtual storage device that includes a plurality of virtual storage disks from a command specifying storage characteristics of the virtual storage disks including number of virtual storage disks, virtual strip size, and fault tolerance of the virtual storage disks. In response to access the virtual storage disks and specifying a virtual storage disk Logical Block Address (LBA), converting the virtual storage disk LBA into a physical storage disk LBA based on a sum of factors that includes a first factor comprising a modulo of the virtual storage disk LBA and virtual strip size, a second factor comprising number of virtual storage disks multiplied by a result of the virtual storage disk LBA minus the first factor, and a third factor comprising a virtual storage disk number multiplied by the virtual strip size.

### BACKGROUND

Storage devices, such as hard disk drives and solid state disks, can be arranged in various configurations for different purposes. For example, storage devices can be configured to provide fault tolerance with different redundancy levels as part of a Redundant Array of Independent Disks (RAID) storage configuration. In such a configuration, the storage devices can be arranged to represent logical or virtual storage and to provide different performance and redundancy based on the RAID level.

### BRIEF DESCRIPTION OF THE DRAWINGS

FIG. 1 is a block diagram of a computer system for virtual storage according to an example implementation.

FIG. 2 is a flow diagram for performing virtual storage according to an example implementation.

FIG. 3 is a block diagram of virtual storage according to an example implementation.

FIG. 4 is a block diagram of virtual storage according to another example implementation.

FIG. 5 is a flow diagram of virtual storage according to another example implementation.

FIG. 6 is a table of virtual storage according to an example implementation.

FIG. 7 is an example block diagram showing a non-transitory, computer-readable medium that stores instructions for a computer system for virtual storage in accordance with an example implementation.

### DETAILED DESCRIPTION

Storage devices, such as hard disk drives and solid state disks, can be arranged in various configurations for different purposes. For example, storage devices can be configured to provide fault tolerance with different redundancy levels as part of a Redundant Array of Independent Disks (RAID) storage configuration. In such a configuration, the storage devices can be arranged to represent logical or virtual storage and to provide different performance and redundancy based on the RAID level. In one example, virtual storage techniques may allow for grouping of a plurality of physical storage from network storage devices to provide single storage device. Redundancy of storage devices can be based on mirroring of data, where data in a source storage device is copied to a mirror storage device (which contains a mirror copy of the data in the source storage device). In this arrangement, if an error or fault condition causes data of the source storage device to be unavailable, the mirror storage device can be accessed to retrieve the data,

Another form of redundancy is parity-based redundancy where actual data is stored across a group of storage devices, and parity information associated with the data is stored in another storage device. If data within any of the group of storage devices were to become inaccessible (due to data error or storage device fault or failure), the parity information from the other non-failed storage device can be accessed to rebuild or reconstruct the data. Examples of parity-based redundancy configurations such as RAID configurations, including RAID-5 and RAID-6 storage configurations. An example of a mirroring redundancy configurations is the RAID-1 configuration, In RAID-3 and RAID-4 configurations, parity information is stored in dedicated storage devices. In RAID-5 and RAID-6 storage configurations, parity information is distributed across all of the storage devices. Although reference is made to RAID in this description, it is noted that some embodiments of the present application can be applied to other types of redundancy configurations, or to any arrangement in which a storage volume is implemented across multiple storage devices (whether redundancy is used or not). A storage volume may be defined as virtual storage that provides a virtual representation of storage that comprises or is associated with physical storage elements such as storage devices. For example, the system can receive host access commands or requests from a host to access data or information on storage volume where the requests include storage volume address information and then the system translates the volume address information into the actual physical address of the corresponding data on the storage devices. The system can then forward or direct the processed host requests to the appropriate storage devices,

When any portion of a particular storage device is detected as failed or exhibiting some other fault condition, the entirety of the particular storage device may be marked as unavailable for use. As a result, the storage volumes may be unable to use the particular storage device, A fault condition or failure of a storage device can include any error condition that prevents access of a portion of the storage device. The error condition can be due to a hardware or software failure that prevents access of the portion of the storage device 3. In such cases, the system can implement a reconstruction or rebuild process that includes generating rebuild requests comprising commands directed to the storage subsystem to read the actual user data from the storage devices that have not failed and parity data from the storage devices to rebuild or reconstruct the data from the failed storage devices. In addition to the rebuild requests, the system also can process host requests from a host to read and write data to storage volumes that have not failed as well as failed, where such host requests may be relevant to performance of the system. Storage systems may include backup management functionality to perform backup and restore operations. Backup operations may include generating a copy of data that is in use to allow the data to be recovered or restored in the event the data is lost or corrupted. Restore operations may include retrieving the copy of the data and replacing the lost or corrupted data with the retrieved copy of the data.

However, some storage systems may not be able to provide redundancy because hardware redundancy may be either too costly or limited by physical space. In some storage systems, data redundancy may be provided either external to the system or not at all. Some storage devices or media devices may occasionally encounter data loss in a non-catastrophic manner which may leads to problem with handling resulting command errors and rebuilding or regenerating the data or returning the subsequent command failures.

The techniques of the present application may help improve the performance or functionality of computer and storage systems. For example, the techniques may implement a storage stack to configure or divide a single physical storage disk or media into multiple separate virtual storage disks in accordance with a process to allow the generation of RAID level fault tolerance with reduced levels of performance loss. The storage stack can be implemented as hardware, software or a combination thereof. These techniques may enable a storage system or a storage controller of a storage system to perform data checking and data repair without the need for multiple real physical disks and with little or no performance loss to most InputOutput (IO) patterns such as from read and write access commands from hosts to access storage.

Computer systems may include striping or data striping techniques to allow the system to segment logically sequential data, such as a file, so that consecutive segments are stored on different physical storage devices. The striping techniques may be used for processing data more quickly than may be provided by a single storage device. The computer may distribute segments across devices allow data to be accessed concurrently which may increase total data throughput. Computer systems may include fault tolerance techniques to allow the system to continue to operate properly in the event of the failure of (or one or more faults within) some of its components. Computer systems may employ Logical Unit (LUN) which may be defined as a unique identifier used to designate individual or collections of storage devices for address by a protocol associated with various network interfaces. In one example, LUNs may be employed for management of block storage arrays shared over a Storage Area Network (SAN). Computer systems may employ Logical Block Address (LBA) addressing techniques for specifying the location of blocks of data stored on computer storage devices. In one example, an LBA may be a linear addressing technique where blocks are located using an integer index, with the first block being LBA 0, the second LBA 1, and so on.

In one example, the techniques of the present application may provide a storage stack to implement a method allow configuration software applications of a computer system to provide a set of options for configuring a single physical storage device or disk (storage media) as a set of virtual storage disks. The configuration or options of the virtual storage disks may include specifying a number of virtual storage disks or devices, virtual strip size of the virtual disks or devices and fault tolerance from a RAID level configuration. The system, upon receiving a configuration command, may save the configuration and relevant information in a persistent manner. Once the system configures or establishes the single physical storage disk, the storage stack may expose a LUN to a host system allowing the host system access to the virtual disks. The total capacity of this LUN may include the original capacity of the physical storage disk less the capacity reserved to accomplish the desired fault tolerance. The host may now access the physical storage disk directly with a logical block address and a command specifying a storage access command such as to read data from or write data to the storage disk.

When a computer system or storage controller of the computer system receives an access command directed to the LUN, it may initiate execution of a virtualization process that includes converting the single command or request into separate requests to the virtual storage disks comprising the LUN. The individual requests may then be converted from the virtual storage disks specifying a virtual storage LBA to a request directed or targeted to the original physical storage disk in accordance to a sum of three factors: a first factor comprising calculation of a modulo of the number of virtual storage disks and virtual strip size, a second factor comprising a calculation of the number of virtual storage disks multiplied by a result of the virtual storage disk LBA minus the first factor, and a third factor comprising a calculation of the virtual storage disk number multiplied by the virtual strip size. The virtual storage disk LBA includes the LBA for a virtual storage disk specified in an access command from a host. The virtual storage strip size may be specified by the configuration command from the host or other configuration application. The number of virtual storage disks may be the configured number of virtual storage disks specified by the configuration command sent from the host. The virtual disk number may be the specific virtual storage disk which is the resulting or actual storage location desired by the host in the access command.

In this manner, these techniques may allow for virtual storage disks or devices of equal LBA strip ranges to be contiguous which may help increase the overall performance or functionality of the system that may be obtained from the physical storage disk or media when sequential LBA operations are being performed. These techniques may apply to recovering data from failed devices from a fault condition from whatever fault tolerance selected.

In another example, the techniques of the present application disclose virtualization module to configure a single physical storage disk to a virtual storage device that includes a plurality of virtual storage disks in response to receipt from a host computer a configuration command specifying storage characteristics of the virtual storage disks including number of virtual storage disks, virtual strip size, and fault tolerance of the virtual storage disks. The virtualization module, in response to an access command from the host computer to access the virtual storage disks and specifying a virtual storage disk LBA, initiate a virtualization process that includes converting the virtual storage disk LBA into a physical storage disk LBA based on a sum of factors that includes: a first factor comprising a modulo of the number of virtual storage disks and virtualstrip size, a second factor comprising number of virtual storage disks multiplied by a result of the virtual storage LBA minus the first factor, and a third factor comprising a virtual storage disk number multiplied by the virtual strip size.

In some examples, the access command may include a read command from the host computer to read data from a virtual LBA of the virtual storage disks. The access command may include a write command from the host computer to write data to a virtual LBA of the virtual storage disks. The virtualization module may be further configured to configure the storage virtual disks in accordance with a fault tolerance level of RAID-4 wherein the parity information is assigned to a parity virtual disk and. In response to a storage fault condition associated with the storage virtual disks, the virtualization module may initiate execution of a rebuild process that includes employing the fault tolerance configuration of the storage virtual disks that includes reading parity information stored in the parity virtual disk to rebuild data as a result of the storage fault condition. The virtualization module may be further configured to configure the storage virtual disks in accordance with a fault tolerance level of RAID-5 wherein the parity information is distributed across parity virtual disks and. In response to a storage fault condition associated with the storage virtual disks, the virtualization module may initiate execution of a rebuild process that includes employing the fault tolerance configuration of the storage virtual disks that includes reading parity information stored across parity virtual disks to rebuild data as a result of the storage fault condition.

In this manner, the techniques of the present application may help improve the performance as well as the functionality of computer and storage systems. For example, this may allow or enable a storage stack of a computer system to build fault tolerance for the purpose of data protection against physical storage disk media errors into a single physical storage disk or media device. In another example, the techniques may allow the storage stack to correct errors on a single physical storage disk or media device transparent to a host application. In another example, these techniques may allow a storage stack to correct errors on a scan initiated by the storage stack for the purpose of proactively finding and correcting errors. In yet another example, these techniques may help increase the performance for storage devices that have optimal performance with sequential IO by placing LBAs for the created LUN on contiguous LBAs on the underlying physical storage disk or media. In another example, these techniques may help fault tolerance operations that require multiple sub-operations (e.g., parity generation), where the virtual conversion or mapping calculations help ensure that those operations will be in close proximity, thereby helping increase performance.

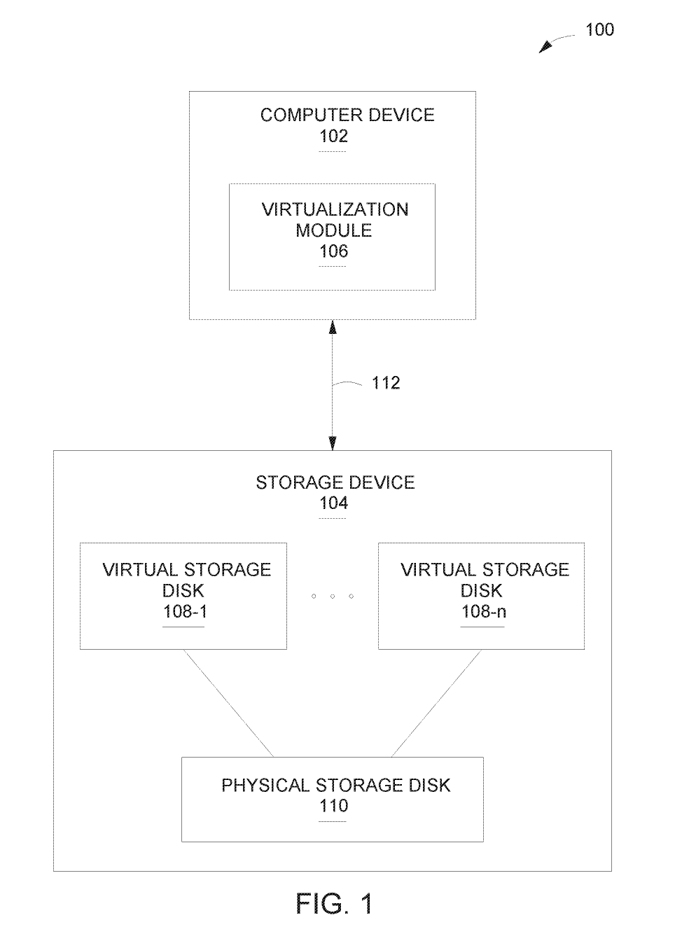

FIG. 1 is a block diagram of a computer system 100 for virtual storage according to an example implementation.

In one example, computer device 102 is configured to communicate with storage device 104 over communication channel 112. The computer device 102 includes a virtualization module 106 to communicate with storage device 104 as well as other devices such as host computers (not shown). The storage device 104 includes a physical storage disk 110 which is configured by virtualization module 106 as a plurality of virtual storage disks 108 (108-1 through 108-n, where n can be any number), as discussed in detail below.

In one example, virtualization module 106 may be configured to communicate with hosts or other computer devices to configure storage device 104. For example, virtualization module 106 may be able to configure single physical storage disk 110 as a virtual storage device that includes a plurality of virtual storage disks 108. The configuration can be performed in response to receipt of a configuration command from a host computer or other computer device. The configuration command may include information about configuration of physical storage disk 110. The configuration command may specify storage characteristics of virtual storage disks 108 including number of virtual storage disks, virtual strip size, and fault tolerance of the virtual storage disks.

The virtualization module 106 may be able to communicate with host computers or other computers to allow hosts to access storage from storage device 104. For example, virtualization module 106 may be able to respond to an access command from a host computer to access virtual storage disks 108 and specifying a virtual storage disk LBA. In response to the command, virtualization module 106 may initiate execution of a virtualization process that includes converting the virtual storage disk LBA into a physical storage disk LBA based on a sum of factors that includes: a first factor comprising a modulo of the virtual storage disk LBA and virtual strip size, a second factor comprising number of virtual storage disks multiplied by a result of the virtual storage disk LBA minus the first factor, and a third factor comprising a virtual storage disk number multiplied by the virtual strip size. The Table 1 below illustrates the virtualization process that generates a physical storage device LBA:

TABLE 1
Physical Storage Device LBA =
(Virtual Storage Disk LBA modulo Virtual Strip size) +
(Virtual Storage Disk LBA − (Virtual Storage Disk LBA modulo Virtual
Strip size)) * Number Virtual Devices) +
(Virtual Disk Number * Virtual Strip Size)

In some examples, the access command may include a read command from a host computer to read data from a virtual LBA of virtual storage disks 108. In another example, the access command may include a write command from a host computer to write data to a virtual LBA of virtual storage disks 108. The virtualization module 106 may be further configured to configure virtual storage disks 108 in accordance with a fault tolerance level of RAID-4 wherein the parity information is assigned to a parity virtual disk and. In response to a storage fault condition associated with the storage virtual disks, virtualization module 106 may initiate execution of a rebuild process. The rebuild process may include having virtualization module 106 employ the fault tolerance configuration of the storage virtual disks that includes a process of reading parity information stored in the parity virtual disk to rebuild data as a result of the storage fault condition,

In another example, virtualization module 106 may be further configured to configure virtual storage disks 108 in accordance with a fault tolerance level of RAID-5 wherein the parity information is distributed across parity virtual disks. In response to a storage fault condition associated with the storage virtual disks, virtualization module 106 may initiate execution of a rebuild process. The rebuild process may include having virtualization module 106 employ the fault tolerance configuration of the storage virtual disks that includes reading parity information stored across parity virtual disks to rebuild data as a result of the storage fault condition,

The computer device 102 may be any electronic device capable of data processing such as a server computer, mobile device, notebook computer and the like. The functionality of the components of computer device 102 may be implemented in hardware, software or a combination thereof. In one example, computer device 102 may include functionality to manage the operation of the computer device. For example, computer device 102 may include functionality to communicate with other computer devices such as host computers to receive access commands from the host computer to access storage from storage device 104.

The storage device 104 may include a single storage disk 110 as shown configured to present logical storage devices to computer device 102 or other electronic devices such as hosts. The storage device 104 is shown to include a single physical storage disk 110 but may include a plurality of storage devices (not shown) configured to practice the techniques of the present application. In one example, computer device 102 may be coupled to other computer devices such as hosts which may access the logical configuration of storage array as LUNS. The storage device 104 may include any means to store data for later access or retrieval. The storage device 104 may include non-volatile memory, volatile memory or a combination thereof. Examples of non-volatile memory include, but are not limited to, Electrically Erasable Programmable Read Only Memory (EEPROM) and Read Only Memory (ROM). Examples of volatile memory include, but are not limited to, Static Random Access Memory (SRAM), and Dynamic Random Access Memory (DRAM). Examples of storage devices may include, but are not limited to, Hard Disk Drives (HDDs), Compact Disks (CDs), Solid State Drives (SSDs), optical drives, flash memory devices and other like devices.

The communication channel 112 may include any electronic communication means of communication including wired, wireless, network based such SAN, Ethernet, FC (Fibre Channel) and the like.

In this manner, the techniques of the present application may help improve the performance as well as the functionality of computer and storage systems such as system 100. For example, these techniques may allow or enable a storage stack of a computer system to generate or build fault tolerance for the purpose of data protection against physical storage disk media errors into a single physical storage disk or media device. In another example, the techniques may allow storage stack to correct errors on a single physical storage disk or media device transparent to a host application. In another example, these techniques may allow a storage stack to correct errors on a scan initiated by the storage stack for the purpose of proactively finding and correcting errors. In yet another example, these techniques may help increase the performance for storage devices that have optimal performance with sequential IO by placing LBAs for the created LUN on contiguous LBAs on the underlying physical storage disk or media. In another example, these techniques may help fault tolerance operations that require multiple sub-operations (e.g., parity generation), where the virtual conversion or mapping calculations help ensure that those operations will be in close proximity, thereby helping increase performance.

It should be understood that the description of system 100 herein is for illustrative purposes and other implementations of the system may be employed to practice the techniques of the present application. For example, computer device 102 is shown as a single component but the functionality of the computer device may be distributed among a plurality of computer devices to practice the techniques of the present application.

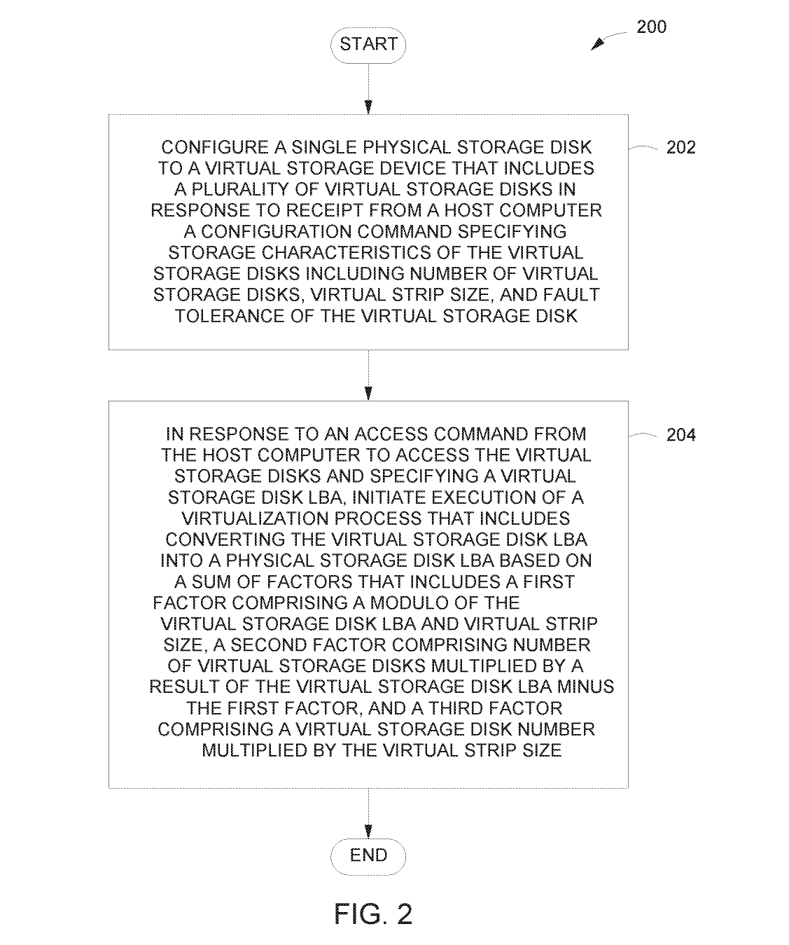

FIG. 2 is a flow diagram for performing virtual storage according to an example implementation.

In one example, to illustrate operation, it may be assumed that computer device 102 is configured to communicate with storage device 104 and another device such as a host computer device,

Processing may begin at block 202, wherein virtualization module 106 configures a single physical storage disk 110 to a virtual storage device that includes a plurality of virtual storage disks 108. The configuration can be performed in response to receipt of a configuration command from a host computer or other computer device. The configuration command may include information about configuration of physical storage disk 110. The configuration command may specify storage characteristics of virtual storage disks 108 including number of virtual storage disks, virtual strip size, and fault tolerance of the virtual storage disks. Processing then proceeds to block 204.

At block 204, virtualization module 106 responds to an access command from a host computer to access virtual storage disks 108 and specifying a virtual storage disk LBA. In response to the command, virtualization module 106 initiates execution of a virtualization process that includes converting the virtual storage disk LBA into a physical storage disk LBA based on a sum of factors that includes: a first factor comprising a modulo of the virtual storage disk LBA and virtual strip size, a second factor comprising number of virtual storage disks multiplied by a result of the virtual storage disk LBA minus the first factor, and a third factor comprising a virtual storage disk number multiplied by the virtual strip size. In one example, once processing of block 204 is completed, processing may then proceed back to block 202 to process further commands or requests. In another example, processing may terminate at the End block.

In another example, processing may include having virtualization module 106 configure virtual storage disks 108 in accordance with a fault tolerance level of RAID-4 wherein the parity information is assigned to a parity virtual disk and. In response to a storage fault condition associated with virtual storage disks 108, virtualization module 106 may initiate execution of a rebuild process. The rebuild process may include having virtualization module 106 employ the fault tolerance configuration of virtual storage disks 108 that includes reading parity information stored in the parity virtual disk to rebuild data as a result of the storage fault condition.

In another example, processing may include having virtualization module 106 configure virtual storage disks 108 in accordance with a fault tolerance level of RAID-5 wherein the parity information is distributed across parity virtual disks and. In response to a storage fault condition associated with virtual storage disks 108, virtualization module 106 may initiate execution of a rebuild process. The rebuild process may include having virtualization module 106 employ the fault tolerance configuration of virtual storage disks 108 that includes reading parity information stored across parity virtual disks to rebuild data as a result of the storage fault condition.

It should be understood that the above process 200 is for illustrative purposes and that other implementations may be employed to the practice the techniques of the present application. For example, computer device 102 is shown as a single component but the functionality of the computer device may be distributed among a plurality of computer devices to practice the techniques of the present application. In another example, a storage controller may be employed with computer device 102 and/or storage device 104 to practice the techniques of the present application.

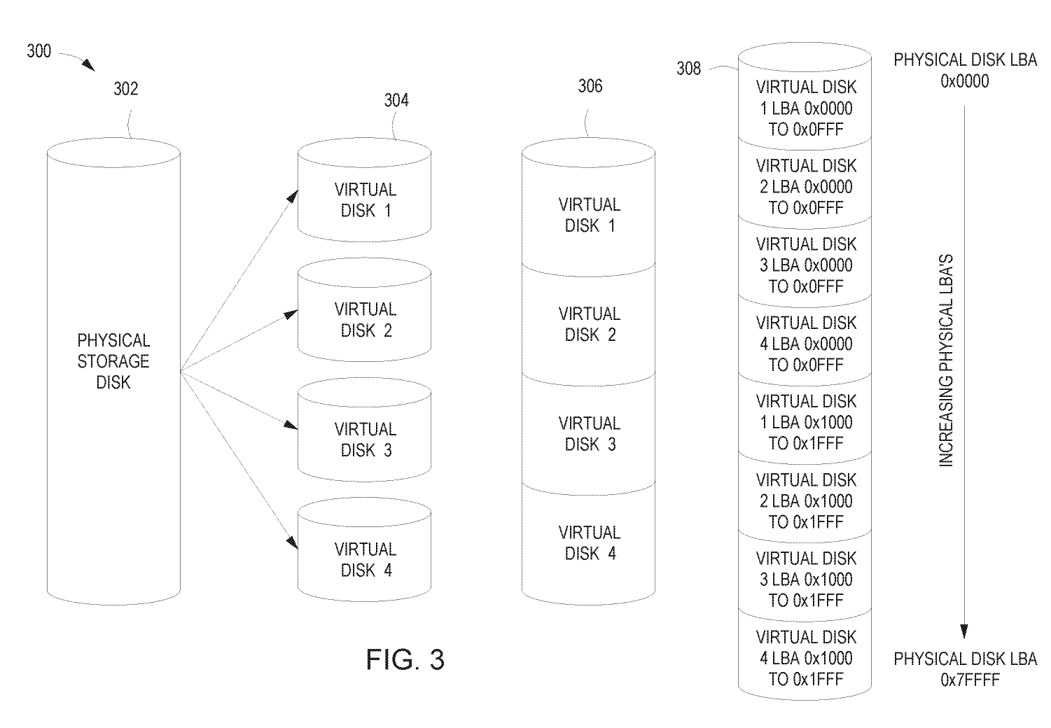

FIG. 3 is a diagram of virtual storage 300 according to an example implementation. As explained above, virtualization module 106 may configure single physical storage disk to a virtual storage device that includes a plurality of virtual storage disks.

For example, virtualization module 106 configures a single physical storage disk 302 to a virtual storage device that includes four virtual storage disks 304 (Virtual Disk 1 through Virtual Disk 4). As explained above, in one example, virtualization module 106 may be configured to execute a virtualization process that includes converting a virtual storage disk LBA into a physical storage disk LBA based on a sum of factors. In this case, to illustrate operation, the virtualization process executed by virtualization module 106 present to a host a plurality of virtual storage disks 304 instead of single physical storage disk 302. In another example, virtualization module 106 configures four virtual storage disks 306 (Virtual Disk 1 through Virtual Disk 4) with a data layout of virtual storage that includes a mapping to physical storage disk 302 without striping. In another example, on the other hand, virtualization module 106 configures four virtual storage disks 308 (Virtual Disk 1 through Virtual Disk 4) with a data layout that includes a virtual storage mapping to physical storage disk 302 with data striping. In addition, the data layout of the four virtual storage disks 308 (Virtual Disk 1 through Virtual Disk 4) are shown to include physical LBA ranges from 0x0000 (hex value) to 0x7FFFF (hex value) in an increasing manner.

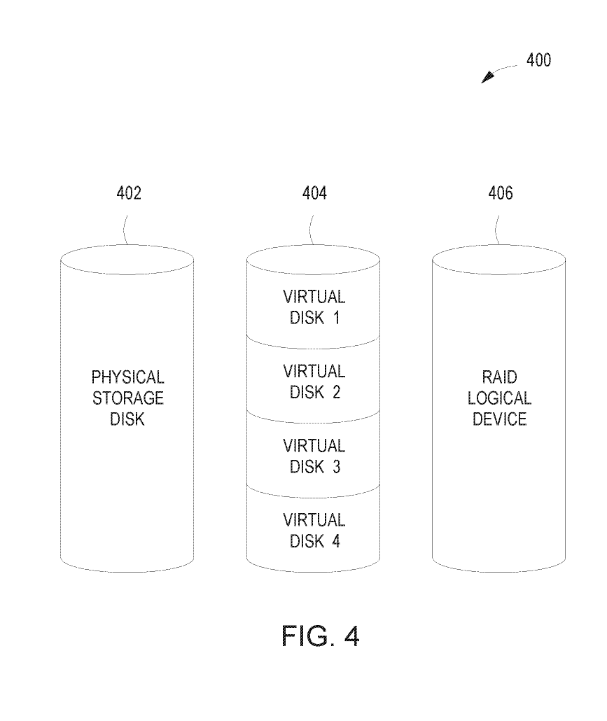

FIG. 4 is a block diagram of virtual storage 400 according to another example implementation. As explained above, in one example, virtualization module 106 may be configured to execute a virtualization process that includes converting the virtual storage disk LBA into a physical storage disk LBA based on a sum of factors. In one example, to illustrate operation, virtualization module 106 configures a single physical storage disk 402 to a virtual storage device that includes four virtual storage disks 404 (Virtual Disk 1 through Virtual Disk 4). The virtualization module 106 presents to a host virtual storage disks 404 instead of single physical storage disk 402. In this case, virtualization module 106 provides RAID fault tolerance where the storage capacity of raw physical storage disk 402 is shown relative to virtual disk mappings 404 and RAID logical device 406 configured in RAID-4 or RAID-5 fault tolerance.

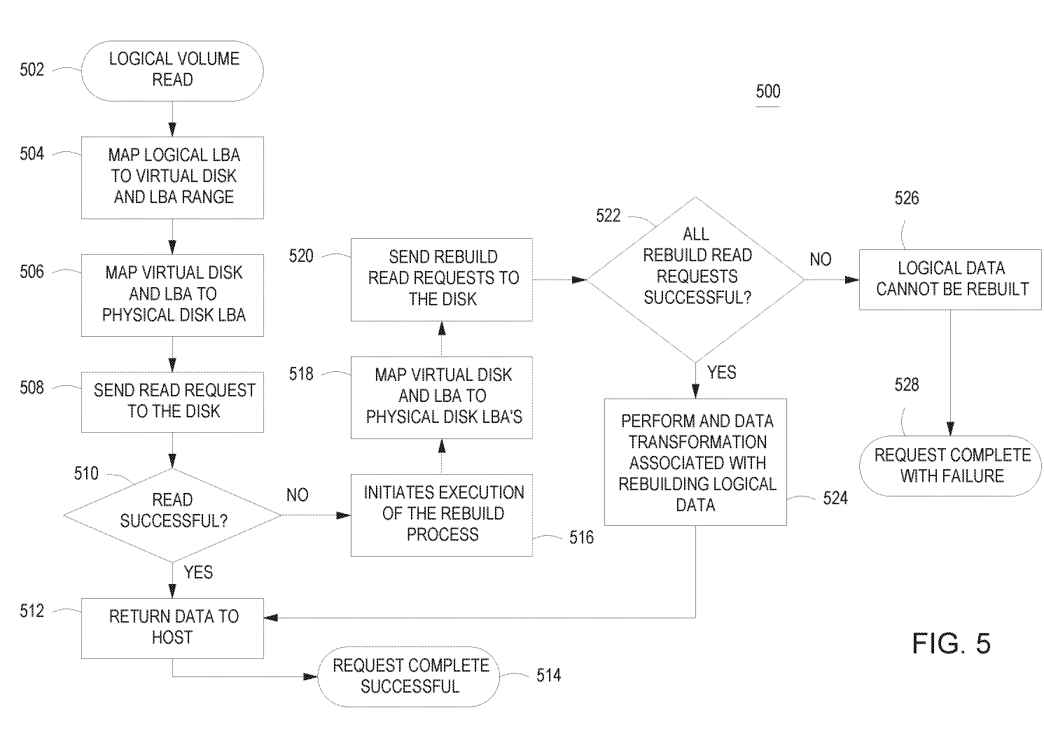

FIG. 5 is a flow diagram of virtual storage 500 according to another example implementation. In one example, to illustrate operation, shown is a data flow of a host read access command for a single block of logical data. It may be assumed, to illustrate operation, virtualization module 106 configures a single physical storage disk 110 to a virtual storage device that includes a plurality of virtual storage disks 108. The configuration may be performed in response to receipt of a configuration command from a host computer or other computer device. The configuration command may include information about configuration of physical storage disk 110. The configuration command may specify storage characteristics of virtual storage disks 108 including number of virtual storage disks, virtual strip size, and fault tolerance of the virtual storage disks. In addition, as explained above, in one example, virtualization module 106 may be configured to execute a virtualization process that includes converting the virtual storage disk LBA into a physical storage disk LBA based on a sum of factors.

Processing may begin at block 502, wherein virtualization module 106 receives a read access command from a host to read a single block of logical data from storage device 104. The read command may include a request to read data for a virtual LBA for a logical volume of the virtual storage disks. Processing then proceeds to block 504.

At block 504, virtualization module 106 maps logical LBA to virtual storage disk and LBA range. In one example, virtualization module 106 converts or maps the virtual or logical LBA received from the host to virtual storage disk and LBA range of virtual storage disks 108 of storage device 104. Processing then proceeds to block 506.

At block 506, virtualization module 106 maps virtual storage disk and LBA to physical storage disk LBA. In one example, virtualization module 106 converts or maps the virtual or logical LBA received from the host to virtual storage disk and LBA range of physical storage disk 110 of storage device 104. Processing then proceeds to block 508.

At block 508, virtualization module 106 sends a read request or command to storage device 104. The storage device 104 may include a storage controller to manage the read request from virtualization module 106. In another example, computer device 102 may include a storage controller to manage the read request from virtualization module 106. Processing then proceeds to block 510.

At block 510, virtualization module 106 checks whether the read request or command was successful. If the read request was successful, then processing proceeds to block 512. On the other hand, if the read request was not successful, then processing proceeds to block 516.

At block 512, virtualization module 106 receives the requested data from storage device 104 and forwards the data to the host that requested the data. Processing proceeds to block 514

At block 514, virtualization module 106 sends a message or notification to the host indicating the read request was successful. Processing may then terminate or return to block 502 to continue to receive read requests from a host.

At block 516, virtualization module 106 initiates execution of a rebuild process. In one example, the rebuild process may include a data regeneration process where one or more virtual storage disks are read depending on RAID fault tolerance configuration.

In another example, processing may include having virtualization module 106 configure virtual storage disks 108 in accordance with a fault tolerance level of RAID-4 wherein the parity information is assigned to a parity virtual disk. In response to a storage fault condition associated with virtual storage disks 108, virtualization module 106 may initiate execution of a rebuild process. The rebuild process may include having virtualization module 106 employ the fault tolerance configuration of virtual storage disks 108 that includes reading parity information stored in the parity virtual disk to rebuild data as a result of the storage fault condition.

In another example, processing may include having virtualization module 106 configure virtual storage disks 108 in accordance with a fault tolerance level of RAID-5 wherein the parity information is distributed across parity virtual disks. In response to a storage fault condition associated with virtual storage disks 108, virtualization module 106 may initiate execution of a rebuild process. The rebuild process may include having virtualization module 106 employ the fault tolerance configuration of virtual storage disks 108 that includes reading parity information stored across parity virtual disks to rebuild data as a result of the storage fault condition. Processing proceeds to block 518.

At block 518, virtualization module 106 executes a conversion or translation process that includes mapping virtual storage disk and LBA's to physical storage disk LBA's. Processing proceeds to block 520.

At block 520, virtualization module 106 send rebuild read requests or commands to the disk. In one example, the read requests are based on the RAID level of the virtual storage disks. Processing proceeds to block 522.

At block 522, virtualization module 106 checks whether the rebuild read requests were successful. If the read requests were successful, then processing proceeds to block 524. On the other hand, if the read requests were not successful, then processing proceeds to block 526.

At block 524, virtualization module 106 perform any data transformation associated with rebuilding logical data. Processing proceeds to block 512.

At block 526, virtualization module 106 determines that logical data cannot be regenerated from the rebuild process. Processing proceeds to block 528.

At block 528, virtualization module 106 sends to the host a message indicating that the read request resulted or completed with a failure. In one example, the message can indicate a failure status indicating “Unrecoverable Read Error”. Processing may then terminate or return to block 502 to continue to receive read requests from a host.

It should be understood that the above process 500 is for illustrative purposes and that other implementations may be employed to the practice the techniques of the present application. For example, virtualization module 106 may handle multiple read commands from a host to access storage device 104.

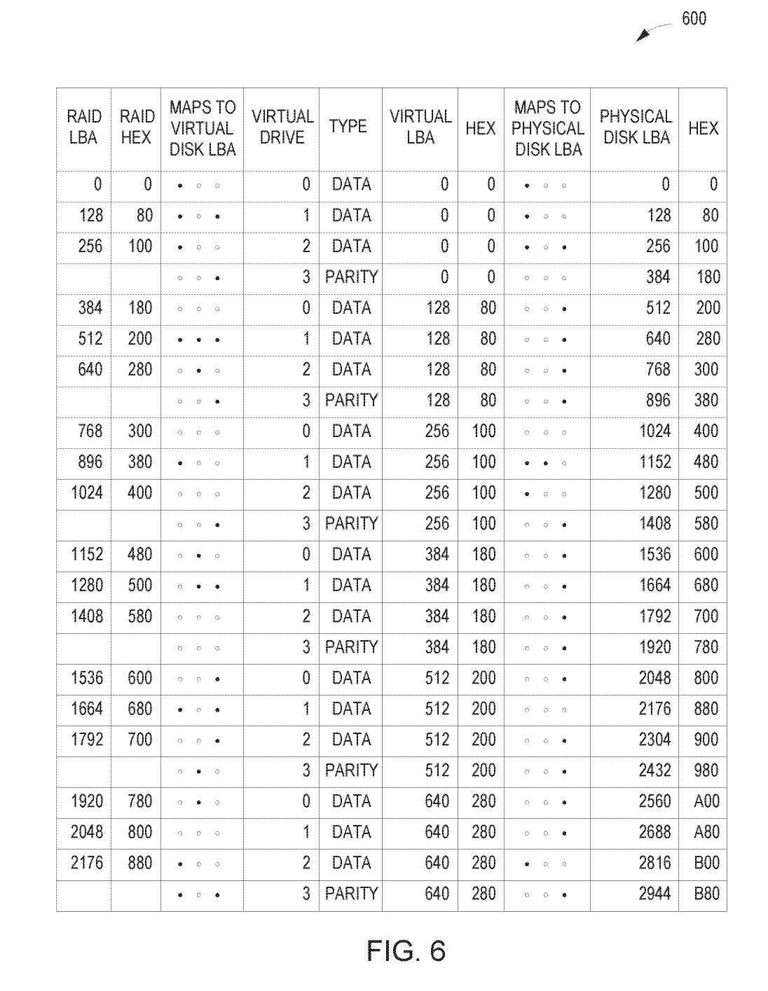

FIG. 6 is a table of virtual storage 600 according to an example implementation. For example, to illustrate, it may be assumed that virtualization module 106 configured storage device 104 to have four virtual storage disks (Virtual Drive 0 through Virtual Drive 3) with a RAID-4 fault tolerance configuration with a 128 block strip.

In one example, virtualization module 106 may receive a read access command from a host to read data from an address specified by LUN LBA 1536 for 16 blocks. The virtualization module 106 converts the read request address information (LUN LBA 1536 for 16 blocks) to Virtual LBA using RAID mapping: Virtual Disk 0, Virtual LBA 512-527. Then virtualization module 106 converts the virtual address information (Virtual Disk 0, Virtual LBA 512-527) to Physical Disk LBA using the above virtualization process: Virtual Disk 0, Virtual LBA 512-527=Physical Disk LBA 2048-2063.

In another example, virtualization module 106 may receive a read access command from a host to read data from an address specified by LUN LBA 2000 for 60 blocks. The virtualization module 106 converts the read request address information (LUN LBA 2000 for 60 blocks) to Virtual LBA via RAID mapping: Virtual Disk 0, Virtual LBA 720-767 and Virtual Disk 1, Virtual LBA 640-651. Then virtualization module 106 converts the virtual address information (Virtual Disk 0, Virtual LBA 720-767 and Virtual Disk 1, Virtual LBA 640-651) to Physical Disk LBA using the virtualization process: Virtual Disk 0, Virtual LBA 720-767=Physical Disk LBA 2640-2687 and Virtual Disk 1 640-651=Physical Disk LBA 2688-2699.

In another example, virtualization module 106 may receive a write access command to write data to an address specified by LUN LBA 1536 for 16 blocks. The virtualization module 106 converts the write request address information to virtual LBA via RAID mapping: Virtual Disk 0, Virtual LBA 512-527 (write), Virtual Disk 1, Virtual LBA 512-527 (read for parity), Virtual Disk 2, Virtual LBA 512-527 (read for parity) and Virtual Disk 3, Virtual LBA 512-527 (for parity write). The virtualization module 106 converts this virtual address information to Physical Disk LBA using the above virtualization process: Virtual Disk 0, Virtual LBA 512-527=Physical Disk LBA 2048-2063, Virtual Disk 1, Virtual LBA 512-527=Physical Disk LBA 2176-2191, Virtual Disk 2, Virtual LBA 512-527=Physical Disk LBA 2304-2319, Virtual Disk 3, Virtual LBA 512-527=Physical Disk LBA 2432-2447.

In this manner, these techniques may provide a LUN with parity fault tolerance, without hardware tolerance, and with adjacent LBA location without exposing any mapping. In one example, the virtual to physical mapping process may be optimized using hardware techniques.

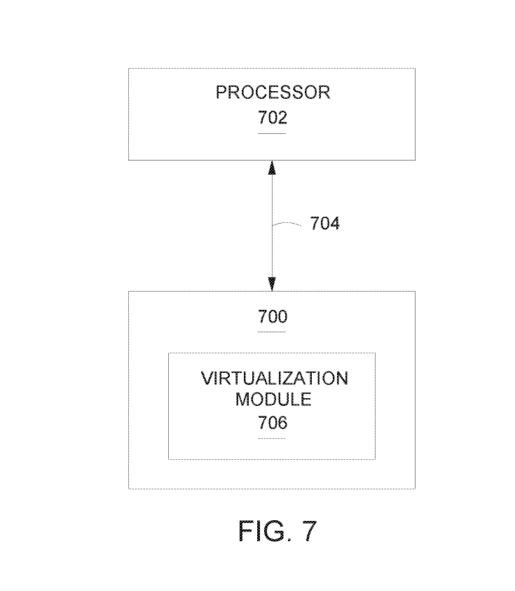

FIG. 7 is an example block diagram showing a non-transitory, computer-readable medium that stores instructions for a computer system for backup operations in accordance with an example implementation. The non-transitory, computer-readable medium is generally referred to by the reference number 700 and may be included in components of system 100 as described herein. The non-transitory, computer-readable medium 700 may correspond to any typical storage device that stores computer-implemented instructions, such as programming code or the like. For example, the non-transitory, computer-readable medium 700 may include one or more of a non-volatile memory, a volatile memory, and/or one or more storage devices. Examples of non-volatile memory include, but are not limited to, EEPROM and ROM. Examples of volatile memory include, but are not limited to, SRAM, and DRAM. Examples of storage devices include, but are not limited to, hard disk drives, compact disc drives, digital versatile disc drives, optical drives, and flash memory devices.

A processor 702 generally retrieves and executes the instructions stored in the non-transitory, computer-readable medium 700 to operate the components of system 100 in accordance with an example. In an example, the tangible, machine-readable medium 700 may be accessed by the processor 702 over a bus 704. A first region 706 of the non-transitory, computer-readable medium 700 may include virtualization module 106 functionality as described herein.

Although shown as contiguous blocks, the software components may be stored in any order or configuration. For example, if the non-transitory, computer-readable medium 700 is a hard drive, the software components may be stored in non-contiguous, or even overlapping, sectors.

What is claimed is:

1. A method comprising:
configuring a single physical storage disk to a virtual storage device that includes a plurality of virtual storage disks in response to receipt from a host computer a configuration command specifying storage characteristics of the virtual storage disks including number of virtual storage disks, virtual strip size, and fault tolerance of the virtual storage disks; and
in response to an access command from the host computer to access the virtual storage disks and specifying a virtual storage disk Logical Block Address (LBA), initiate execution of a virtualization process that includes converting the virtual storage disk LBA into a physical storage disk LBA based on a sum of factors that includes:
a first factor comprising a modulo of the virtual storage disk LBA and virtual strip size,
a second factor comprising number of virtual storage disks multiplied by a result of the virtual storage LBA minus the first factor, and
a third factor comprising a virtual storage disk number multiplied by the virtual strip size.

2. The method of claim 1, wherein the access command includes a read command from the host computer to read data from a virtual storage disk LBA of the virtual storage disks.

3. The method of claim 1, wherein the access command includes a write command from the host computer to write data to a virtual storage disk LBA of the virtual storage disks,

4. The method of claim 1, further comprising configuring the storage virtual disks in accordance with a fault tolerance level of Redundant Array Of Independent Disks (RAID-4) wherein the parity information is assigned to a parity virtual disk and, in response to a storage fault condition associated with the storage virtual disks, initiating execution of a rebuild process that includes employing the fault tolerance configuration of the storage virtual disks that includes reading parity information stored in the parity virtual disk to rebuild data as a result of the storage fault condition.

5. The method of claim 1, further comprising configuring the storage virtual disks in accordance with a fault tolerance level of RAID-5 wherein the parity information is distributed across parity virtual disks and, in response to a storage fault condition associated with the storage virtual disks, initiating execution of a rebuild process that includes employing the fault tolerance configuration of the storage virtual disks that includes reading parity information stored across parity virtual disks to rebuild data as a result of the storage fault condition.

6. A computer comprising:
a virtualization module to:
configure a single physical storage disk to a virtual storage device that includes a plurality of virtual storage disks in response to receipt from a host computer a configuration command specifying storage characteristics of the virtual storage disks including number of virtual storage disks, virtual strip size, and fault tolerance of the virtual storage disks, and
in response to an access command from the host computer to access the virtual storage disks and specifying a virtual storage disk Logical Block Address (LBA), initiate execution of a virtualization process that includes conversation of the virtual storage disk LBA into a physical storage disk LBA based on a sum of factors that includes:
a first factor comprising a modulo of the virtual storage disk LBA and virtual strip size,
a second factor comprising number of virtual storage disks multiplied by a result of the virtual storage disk LBA minus the first factor, and
a third factor comprising a virtual storage disk number multiplied by the virtual strip size.

7. The computer of claim 6, wherein the access command includes a read command from the host computer to read data from a virtual storage disk LBA of the virtual storage disks.

8. The computer of claim 6, wherein the access command includes a write command from the host computer to write data to a virtual storage disk LBA of the virtual storage disks.

9. The computer of claim 6, wherein the virtualization module further comprising to configure the storage virtual disks in accordance with a fault tolerance level of Redundant Array Of Independent Disks (RAID-4) wherein the parity information is assigned to a parity virtual disk and, in response to a storage fault condition associated with the storage virtual disks, initiate execution of a rebuild process that includes employing the fault tolerance configuration of the storage virtual disks that includes reading parity information stored in the parity virtual disk to rebuild data as a result of the storage fault condition.

10. The computer of claim 6, wherein the virtualization module further comprising to configure the storage virtual disks in accordance with a fault tolerance level of RAID-5 wherein the parity information is distributed across parity virtual disks and, in response to a storage fault condition associated with the storage virtual disks, initiating execution of a rebuild process that includes employing the fault tolerance configuration of the storage virtual disks that includes reading parity information stored across parity virtual disks to rebuild data as a result of the storage fault condition.

11. An article comprising a non-transitory computer readable storage medium to store instructions that when executed by a computer to cause the computer to:
configure a single physical storage disk to a virtual storage device that includes a plurality of virtual storage disks in response to receipt from a host computer a configuration command specifying storage characteristics of the virtual storage disks including number of virtual storage disks, virtual strip size, and fault tolerance of the virtual storage disks; and
in response to an access command from the host computer to access the virtual storage disks and specifying a virtual storage disk Logical Block Address (LBA), initiate execution of a virtualization process that includes conversion of the virtual storage disk LBA into a physical storage disk LBA based on a sum of factors that includes:
a first factor comprising a modulo of the virtual storage disk LBA and virtual strip size,
a second factor comprising number of virtual storage disks multiplied by a result of the virtual storage disk LBA minus the first factor, and
a third factor comprising a virtual storage disk number multiplied by the virtual strip size.

12. The article of claim 11, wherein the access command includes a read command from the host computer to read data from a virtual storage disk LBA of the virtual storage disks.

13. The article of claim 11, wherein the access command includes a write command from the host computer to write data to a virtual storage disk LBA of the virtual storage disks.

14. The article of claim 11, further comprising instructions that if executed cause a computer to configure the storage virtual disks in accordance with a fault tolerance level of Redundant Array Of Independent Disks (RAID-4) wherein the parity information is assigned to a parity virtual disk and, in response to a storage fault condition associated with the storage virtual disks, initiate execution of a rebuild process that includes employing the fault tolerance configuration of the storage virtual disks that includes reading parity information stored in the parity virtual disk to rebuild data as a result of the storage fault condition.

15. The article of claim 11, further comprising instructions that if executed cause a computer to configure the storage virtual disks in accordance with a fault tolerance level of RAID-5 wherein the parity information is distributed across parity virtual disks and, in response to a storage fault condition associated with the storage virtual disks, initiating execution of a rebuild process that includes employing the fault tolerance configuration of the storage virtual disks that includes reading parity information stored across parity virtual disks to rebuild data as a result of the storage fault condition.
